(19) United States
(12) Patent Application Publication
(10) Pub. No.: US 2006/0227772 A1
(43) Pub. Date: Oct. 12, 2006

(54) Method and system for packet data communication between networks

(75) Inventor: Didier Plaindoux, Gratens (FR)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/093,050

(22) Filed: Mar. 30, 2005

(51) Int. Cl. H04L 12/56; H04L 12/28

(52) U.S. Cl. 370/389

(57) ABSTRACT

A system and method for packet data transmission is described, particularly in the case of dispersed networks that are at least occasionally in data communication with each other (such as in a wide area network), in which efficient packet transmission is provided while avoiding traffic bottlenecks and the like. In general, a combination of multicast communication and peer-to-peer communication is used to set up data links between nodes (such as servers and the like) on different networks, especially in a wide area network environment. Multicast communication is characteristically used within a respective network whereas peer-to-peer communication is used between nodes in different networks. The disclosed system and method is useful in network environments involving third-party application service providers.

### FIELD OF THE INVENTION

The present invention relates to a method and system for establishing packet data communication paths or links between nodes located on different networks, particularly dispersed or distributed networks such as those which comprise a wide area network.

### BACKGROUND OF THE INVENTION

In general, various computing network configurations are known. Two conceptually related network forms are local area networks (frequently referred to as LANs) and wide area networks (frequently referred to as WANs), the two primarily differing with respect to physical extent.

LANs are usually high-speed networks that physically extend over relatively small areas, such as, for example, within an office, or within a building, or within a small group of relatively proximate buildings. A typical example of a LAN might include, for example, a central document server connected over a network to one or more workstation terminals, printers, and other nodes, as one might find in an office environment.

WANs are networks that physically extend over comparatively larger areas and LANs, such as, for example, widely spaced apart offices, buildings, and the like within cities, between cities, and even between states and between countries. WANs may have a topography similar to a LAN (e.g., many nodes on a network without necessarily any clustering or other form of sub-level organization), but frequently comprise interconnected networks such as LANs. For example, a network structure in which the LANs in geographically different offices of a company are interconnected would be a WAN.

LANs on a WAN may communicate with each other by a public communication network, such as, without limitation, the Internet, and may be physically embodied by telephone lines (such as POTS (Plain Old Telephone Service) or PSTN (Public Switched Telephone Network)), ISDN (Integrated Services Digital Network), Frame Relay, ATM (Asynchronous Transfer Mode), satellite communication, or other high speed services.

In general, for a network to function properly, it is necessary for each node on the network (e.g., printers, work stations, servers, etc.) to know what other nodes are also present on the network. In theory, this information can be manually updated as necessary (for example, by a network administrator) each time a network node is added or deleted, but such revisions quickly become cumbersome if not effectively impossible to implement.

It is therefore conventional, at least at the LAN level, to provide dynamic intra-network notification of node additions and deletions. That is, in order to facilitate network management, it is known to automatically notify other nodes on a LAN when a node is added and/or deleted. For example, when a new node, such as a printer, is added to a LAN, it dynamically announces its presence on the LAN (sometimes referred to in the art as “publishing” or “publication”) to other elements on the LAN, such as workstations and document servers.

For example, a newly added node may broadcast a message to all other nodes on the LAN to inform other nodes of its new existence/presence on the LAN. This type of notification is usually done using a multicast message to the other nodes on the network, wherein the notifying node transmits individual copies of the same message messages to each node on the network at each node's respective network address. An example of a known protocol for implementing multicast messaging is the Internet Group Management Protocol (“IGMP”). (In contrast, a unicast message is a single copy of a message sent to a single node at its respective network address.)

Once a new node is recognized on the network, the other nodes on the LAN can communicate with the newly-recognized node.

While this arrangement is suitable for LANs, there are difficulties in extending this idea to multicast publication of nodes on different respective networks in a WAN, which are connected by an intervening public communication network.

FIG. 1 illustrates a conventional approach for establishing communication between LAN 100 and LAN 300 of a WAN 300. In general, each LAN 100, 200 includes a plurality of nodes thereon, such as a plurality of servers 102, 104, 106, 108, 110, as well as servers 202, 204, 206, 208, respectively. LAN 100 may include a proxy server 112, whereas LAN 200 is provided with a proxy server 210 connected/connectable to proxy server 112 across a public network 400 (such as the Internet).

Therefore, with the network arrangement shown in FIG. 1, a given server 102, 104, 106, 108, 110 on the first LAN 100 communicates with a given server 202, 204, 206, 208 of second LAN 200, by way of proxy server 112 in communication with a proxy server 210. However, FIG. 1 clearly illustrates at least one significant problem with this arrangement—the fact that all server traffic on the respective LANs must travel via corresponding proxy servers creates a bottleneck for data transmission and is particularly problematic for distributed networks with respect to the connection efficiencies sought to be achieved by networking.

Moreover, LANs 100, 200 customarily use firewalls 114, 212 to protect and/or control access thereto. A firewall is a type of proxy server, which, most generally, substitutes its IP address for that of a node on the network that the firewall is protecting, when that node is in the process of communicating with an entity outside of the network. Thus, in a WAN, a given node on one LAN (such as, for example, server 102 on LAN 100) may not be visible (i.e., “published”) to another node on another LAN (such as server 204 on LAN 200) because of a firewall (such as firewall 114 and/or 212) interposed therebetween. It will be appreciated that this impedes packet addressing back to a node whose address cannot be readily identified outside of the LAN on which it resides because of the firewall.

Another possible approach to publication across a WAN is to use a peer-to-peer connection between respective agents operating on respective LANs, as schematically illustrated in FIG. 2.

In WAN 300′ as illustrated in FIG. 2, each LAN 100′, 200′ uses multicasting messaging to publish the addition of new nodes (such as servers 102′, 104′, 106′, 108′, 110′, 112′ or servers 202′, 204′, 206′, 208′, 210′ on LAN 100′ and LAN 200′ respectively. LANs 100′, 200′ may for example use IGMP to implement multicast messaging.

One of the servers 112′ on LAN 100′ and one of the servers 202′ on LAN 200′ may be provided with an agent 112a′, 202a′ running thereon. As is known in the art, an agent is software that operates on a system, such as a network server, to provide certain functionalities. In particular, agents according to the present invention are configured to be able to communicate information between a multicast messaging side and a unicast message side (in this case, between the agents between LANs 100′ and 200′. Because of the agents' ability to communicate between multicast messaging and unicast messaging, these agents are further indicated in FIG. 2 by “M/U” for “multicast/unicast” and are therefore sometimes referred to herein as M/U agents.

According to the conventional approach illustrated in FIG. 2, the “new” servers on LANs 100′ and 200′ announce (i.e., “publish”) their presence using multicast messages sent to the other servers on the respective LANs, in a manner known in the art and as discussed hereinabove. However, at least one server on each LAN is particularly configured to communicate via a peer-to-peer connection (for example, over the Internet, using a TCP/IP protocol) with a counterpart server on another LAN.

For example, server 112′ on LAN 100′ is configured to operate M/U agent 112a′. As other servers on LAN 100′ transmit multicast message packets over LAN 100′, server 112′ receives such messages like the other servers on the LAN. However, server 112′ is additionally configured to buffer the received multicast message packets under the control of M/U agent 112a′, and to periodically pass the multicast packets to the other LAN 200′. Therefore, in theory, LAN 200′ can be made aware of the nodes present on LAN 100′. However, passing the multicast message packets between LAN 100′ and LAN 200′, without any other addressing, raises the possibility of conflicting host-port node identifications between two different LANs.

### SUMMARY OF THE PRESENT INVENTION

The present invention therefore relates to the effective propagation of multicast packets between LANs on a WAN while avoiding any problems in packet addressing. The present invention also relates to establishing packet data communication connections between LANs on a WAN.

In general, the present invention relates to making a first LAN on a WAN aware of node additions on a second LAN on the WAN using multicast/unicast agents (“M/U agents”) operating on the respective LANs. The M/U agents are each provided with definitions of other M/U agents in other LANs (sometimes referred to herein as “acquaintances”) to which data should be passed. In addition, packet addressing is dynamically controlled so as to be indicative of packet entry and/or packet exit information (such as host-port information) for a packet's originating LAN, in addition to information corresponding to the server from which the packet originates.

In this manner, even though packet transmission between LANs initially relies on agent-to-agent connections, a direct peer-to-peer connection is finally established, so that packet transmission issues discussed above, such as proxy server bottlenecks and hidden node addresses (due to firewalls and the like) can be addressed.

### BRIEF DESCRIPTION OF THE DRAWINGS

The presently claimed invention, as described herein, will be even better understood with reference to the attached drawings, in which:

FIG. 1 is an illustration of a related art WAN;

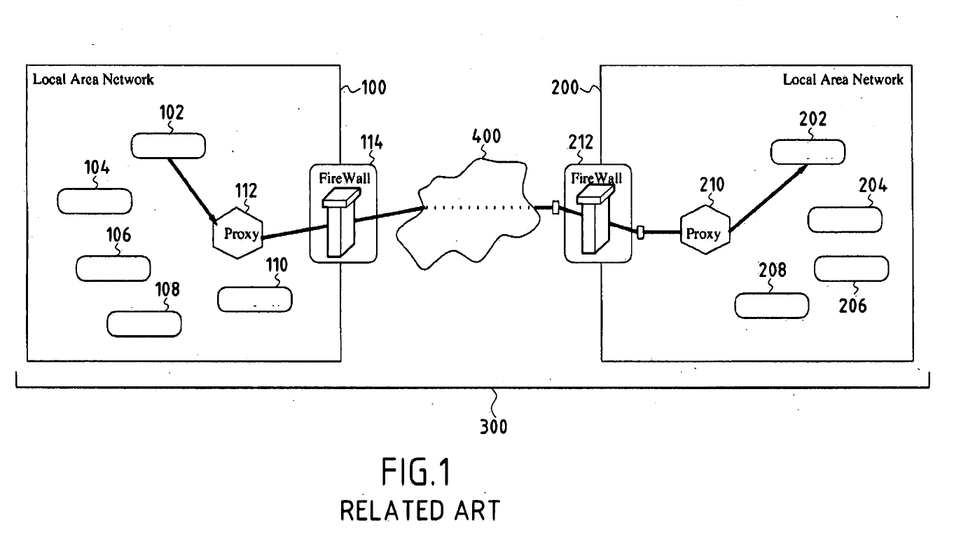

FIG. 2 is an illustration of another related art WAN;

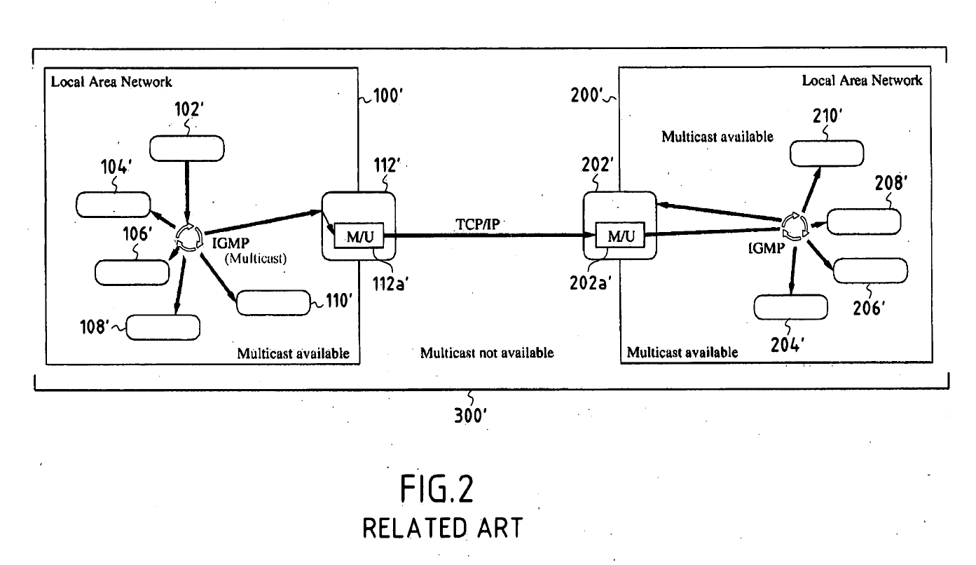

FIG. 3 illustrates a packet data communication process between two WANs on a LAN according to the present invention; and

FIG. 4 is a schematic representation generally corresponding to FIG. 3 for illustrating the handling of packet addressing according to the present invention.

### DETAILED DESCRIPTION OF THE INVENTION

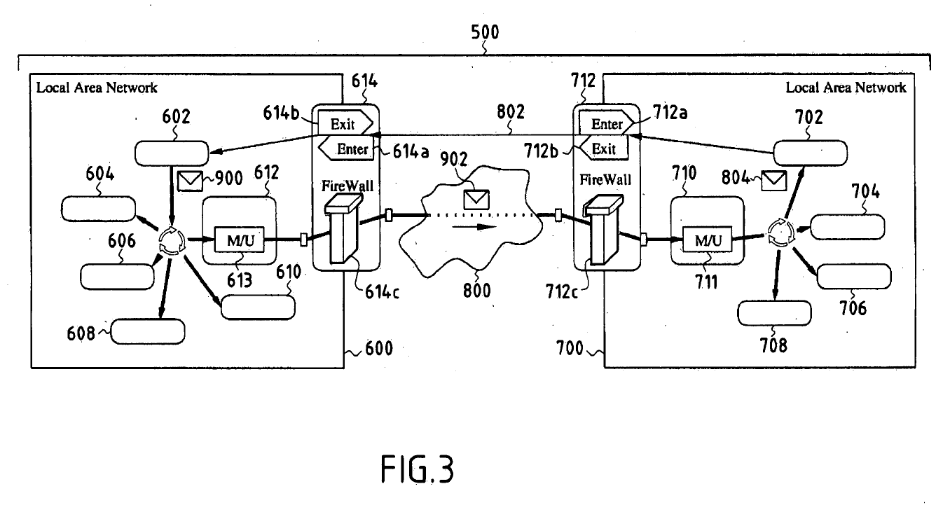

FIG. 3 illustrates a process of packet communication between nodes on different LANs according to the present invention, which LANs together constitute a WAN.

Specifically, a WAN 500 comprises a plurality of LANs. For illustrative purposes, two LANs 600, 700 are illustrated, but more than two LANs are contemplated within the present invention. LANs 600, 700 are at least occasionally connected in a known manner so as to be able to transmit data therebetween, such as by way of a public communications network, such as the Internet, or by telephone, cable, etc. The basic structure of a WAN comprised of a plurality of interconnected LANs is considered well-known in the art, such that a detailed explanation in this regard is omitted here.

LAN 600 has a plurality of nodes thereon, such as, strictly by way of example, a plurality of servers 602, 604, 606, 608, 610, and 612. The nodes on LAN 600 communicate with each other through the exchange of packet data in a known manner. Each node is configured to announce (i.e., publish) its presence on LAN 600 by sending a multicast message to the other nodes on LAN 600, using, for example, IGMP, or any other suitable data protocol, as is known in the art.

One of the nodes, such as server 612, may be provided with an M/U agent 613 operating thereon. M/U agent 613 is generally operable to pass information associated with a multicast publication of a new node on LAN 600 to a peer-to-peer connection by which LAN 600 is connected to another LAN 700. (The peer-to-peer connection to LAN 700 is discussed in more detail below.)

LAN 600 is associated with network packet data entry and exit definitions 614a, 614b which are generally implemented at 614. The network packet data entry and exit definitions 614a, 614b are the points by which LAN 600 is connected to other networks, and are typically defined in terms of respective host-port designations.

Frequently, network packet data entry and exit definitions for the LAN 600 include a firewall capacity 614c which selectively controls and/or blocks access to LAN 600 in a known manner. Usually, access to LAN 600 is directly implemented by way of firewall 614c. However, a notional “enter” 614a and “exit” 614b are illustrated separately from firewall 614c in order to facilitate the explanation of the present invention hereinbelow.

LAN 700 is generally similar to LAN 600. It also includes a plurality of nodes thereon, such as, for example, servers 702, 704, 706, 708, and 710. The nodes on LAN 700 also inform each other as to the addition of new nodes by way of multicast publication, as in LAN 600. Multicast messaging within LAN 700 may be implemented by known protocols, such as IGMP. Packet data entry and exit from LAN 700 is indicated generally at 712, and includes at least a network packet data entry 712a and network packet data exit 712b. As before, the entry and exit to LAN 700 may be implemented in a firewall 712c.

Finally, as mentioned above, LAN 600 and LAN 700 are at least occasionally connected by way of an intermediate communication network 800 over which data can be transferred therebetween, especially a public communication network such as, for example, the Internet.

FIG. 3 generally illustrates data communication between LAN 600 and LAN 700 according to the present invention.

In LAN 600, the envelope symbol at 900 represents a multicast message packet transmitted by server 602 to publish its presence on LAN 600, as discussed above. Packet 900 is, by definition, transmitted to each node on LAN 600, including to server 612, on which an agent 613 (specifically, a multicast/unicast or M/U agent) is operating. M/U agent 613 is operable to interface between multicast packets and unicast packets, in a known manner. In particular, M/U agent 613 is preconfigured according to the present invention to have one or more specific network destinations (sometimes referred to herein as acquaintances) to which received multicast packets are sent. In one example, M/U agent 613 has M/U agent acquaintances on other LANs, such as M/U agent 711 (operating on server 711) on LAN 700.

Accordingly, a message packet 902 corresponding to multicast message packet 900 is thereafter passed from server 612 (at the control of M/U agent 613 operating thereon) to server 710 on LAN 700 (on which M/U agent 711 operates). In this example, M/U agent 613 is preconfigured to consider M/U agent 711 as an acquaintance to which packets are to be passed. It will be recognized, naturally, that the present example is limited to two LANs on a WAN in order to facilitate the explanation thereof, but the description can be naturally expanded to more than two LANs, each being provisioned in a manner similar to LAN 600 and LAN 700, each including at least one M/U agent in accordance with the foregoing.

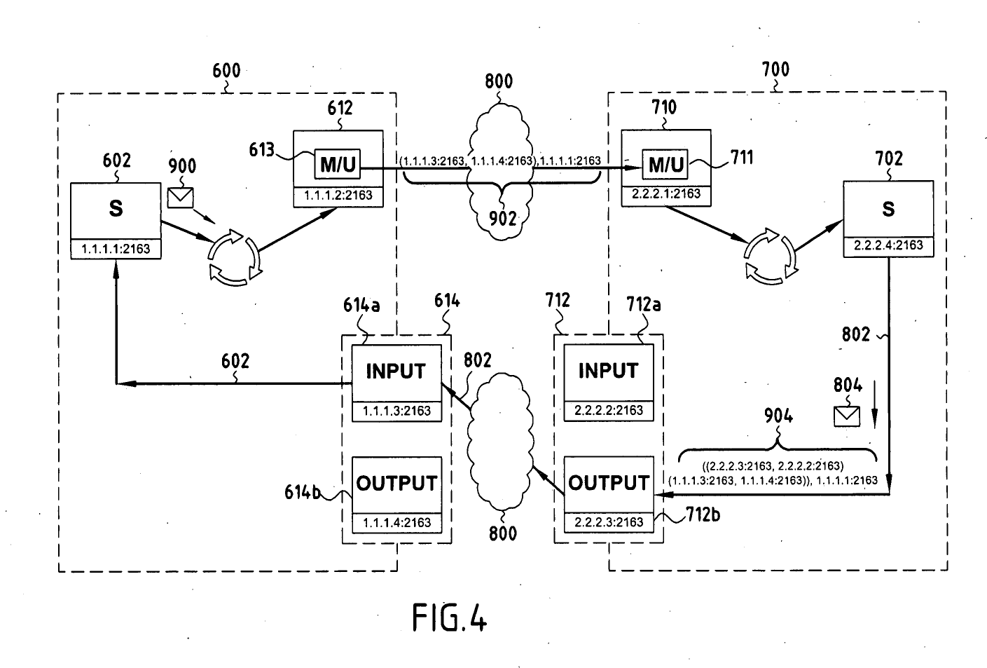

Message packet 902 is a unicast message packet corresponding to multicast message packet 900, and has been particularly addressed for transmission across network 800. This addressing is further described below with respect to FIG. 4.

Once server 710 receives the packet 902 from LAN 600 (specifically, from server 612 on LAN 600), server 710 sends it to the other nodes on LAN 700 as a multicast message packet 804 in a known manner, such that each node on LAN 700 is effectively made aware of server 602 on LAN 600.

Once the nodes on LAN 700 are informed as to the presence of the new node on LAN 600 (such as, in this example, server 602), a given node of LAN 700 can initiate data communication with server 602.

For example, server. 702 (arbitrarily chosen for this explanation by way of example) now has network address information corresponding to server 602. Server 702 is therefore able to establish a data communication pathway with server 602 by way of network packet data exit 712b of LAN 700 and network packet data entry 614a of LAN 600 as a result of the network addressing information transmitted by packet 902, as is described in detail below. In particular, the data communication pathway 802 may be a peer-to-peer connection between servers 702 and 602 across intervening network 800. In FIG. 3, envelope symbol 804 represents a packet sent from server 702 to server 602 by way of data communication pathway 802.

To explain the process generally described in FIG. 3, reference is now made to FIG. 4 which schematically illustrates certain aspects of the features discussed above. Where appropriate, corresponding elements in FIGS. 3 and 4 are indicated by the same reference numerals. On other hand, certain features illustrated in FIG. 3 are not shown in FIG. 4 to simplify the description of the present invention. In particular, FIG. 4 illustrates the manner in which packets are addressed according to the present invention in order to implement peer-to-peer communication between LANs on a WAN.

In FIG. 4, LAN 600 and LAN 700 are illustrated in a generic manner by respective dotted line boxes. FIG. 4 more specifically illustrates the previously discussed example of communication between server 602 on LAN 600 and server 702 on LAN 700, and specifically illustrates a method of packet addressing that permits the functionality of the present invention.

In the example of FIG. 4, server 602 is identifiable, at least in part, by its host-port address (e.g., 1.1.1.1:2163). In a manner known in the conventional art, server 602 announces (publishes) its presence on LAN 600 by sending a multicast message packet 900 across LAN 600, including to server 612 upon which an M/U agent 613 is active. As can be seen in FIG. 4, LAN 600 has a network packet data entry 614a and a network packet data entry 614b, each having a respective host-port definition. In this example, network packet data entry 614a is identifiable as 1.1.1.3:2163 and network packet data entry 614b is identifiable as 1.1.1.4:2163.

As discussed above, M/U agent 613 is preconfigured with one or more “acquaintance” definitions which are, in particular, counterpart M/U agents associated with other LANs on the WAN to which multicast message information is systematically passed. Acquaintances are defined for a given M/U agent in terms of information sufficient to permit establishment of a peer-to-peer connection between the M/U agents, including at least the host-port identification of the acquaintance M/U server, and possibly network data entry and exit definitions of a destination LAN upon which the acquaintance M/U resides. However, the establishment of a peer-to-peer connection between M/U agents in this manner is believed to be conventional.

In the example illustrated in FIG. 4, one such acquaintance of M/U agent 613 is M/U agent 711 operating on server 710 on LAN 700. Thus, upon receipt of multicast message packet 900 at server 612, M/U agent 613 is operable to automatically send a corresponding unicast message 902 to its acquaintance M/U agent 711 over network 800. Unicast message 902 may be transmitted based on, for example, the TCP/IP protocol.

This message 902 is addressed using at least the network packet data entry definition for LAN 600 (i.e., 1.1.1.3:2163), the network packet data exit definition for LAN 600 (i.e., 1.1.1.4:2163), and the host-port identification of server 602 (i.e., 1.1.1.1:2163). Thus, according to the present invention, a given server is identified on the basis of information of its LAN, in addition to its own network host-port identification.

It should be also noted that acquaintance definitions do not have to be symmetrical according to the present invention. For example, in FIG. 4, M/U agent 613 may be preconfigured to consider M/U agent 711 an acquaintance, but M/U agent 711 may not necessarily be preconfigured to consider M/U agent 613 an acquaintance.

Once the information 902 is received by the acquaintance M/U agent 711 on LAN 700, it operates in a known manner to allow the server 710 on which it resides to generate a corresponding multicast message to disseminate the publication of server 602 across LAN 700, including to, for example, server 702. The packet sent by multicast from server 710 (indicated in one part in FIG. 4 schematically by a box marked 904, and also between server 702 and network data output 712b in terms of its addressing information) includes the same addressing information as indicated by 902, plus additional host-port identification information corresponding to network packet data entry 712a and network packet data exit 712b. The use of this information is discussed in further detail below.

Upon receipt of this publication information, server 702 is capable of establishing a peer-to-peer connection 802 with server 602. Server 702 possesses network address information sufficient to communicate with server 602 directly.

However, when server 702 passes a message packet 804 to server 602 via 802, that packet also has attached to it its own LAN network packet data entry and exit definition information in addition to the addressing information corresponding to the publication of server 602. The resultant addressing information, an example of which is indicated at 904, therefore additionally includes the network packet data exit host-port definition for LAN 700 (i.e., 2.2.2.3:2163), the network packet data entry host-port definition for LAN 700 (i.e., 2.2.2.2:2163), as well as the network packet data entry and exit host-port definitions for LAN 600 and the host-port identification of server 602 (as initially transmitted).

The assembled addressing information indicated at 904 permits the establishment of a peer-to-peer data communication pathway 802 that travels between LAN 700 and LAN 600 by way of network packet data exit 712b of LAN 700 and network packet data entry 614a of LAN 600, and ultimately to server 602, in accordance with the information 904 conveyed with packet message 804.

In turn, if or when server 602 replies to server 702, server 602 has been provided with packet addressing information sufficient to establish a peer-to-peer connection (not shown) with server 702. In particular, this peer-to-peer connection would pass by way of network packet data exit 614b of LAN 600 and network packet data entry 712a of LAN 700, in accordance with the information 904 conveyed with message packet 804.

It should be noted that the order in which packet address information, such as that indicated at 904, may be made significant. For example, the order of address information elements may be predefined so that, for example, packet header data containing this information can be properly interpreted by elements on the network.

The method and system as described hereinabove can form the basis for useful network environments. Most generally, an end user can run applications on a WAN with little or no thought as to where hardware resources are located, or where the underlying data is stored. The method and system described above facilitates connectivity across the network.

In a particular example, multiple LANs can be interconnected according to the foregoing description. However, one or more of the LANs may be owned by a third party for providing certain functions as an outside service provider. For example, a business having its own WAN, may additionally have network connectivity with a third party application service provider (sometimes referred to in the art as “ASP”) that provides specific application functionality, such as, without limitation, accounting services, information storage and retrieval services, human resources data management, etc. Thus, the business can enjoy certain application functionality, without having to put into place its own network resources. It will be appreciated that security issues are even more sensitive when providing network connections with an unrelated entity. Thus, while it is desirable to be able to easily pass data between LANs (across firewalls and the like) to provide useful functionality, the above-described ability to dynamically control packet addressing is useful from a security standpoint. With respect to this latter, for example, data connections can be controlled to be bidirectional or unidirectional as desired, or can be permitted with only specific network nodes (for example, servers). For example, an ASP may control data connections from an outside client business so that the client business can only interact with server equipment specifically designated for its use.

In accordance with the foregoing, the third party ASP may also connect other network functionality, such as its billing system so that a client business can be charged (for example, on the basis of the volume of data transferred, or on the basis of time of connection) for its connection with the third party ASP's resources.

While the present invention has been described with respect to what are believed to be the most practical embodiments thereof, it is particularly noted that this is by way of example only, and appropriate modifications and variations thereof are possible within the spirit and scope of the claims appended hereto.

What is claimed is:

1. A method for dynamically establishing a packet data connection between a first node on a first network and a second node on a second network, the first and second networks each including a packet entry and a packet exit, the method comprising:
passing a first packet from the first node to a first intermediary node on the first network;
at the first intermediary node, attaching first information to the first packet, the attached information indicative of the first network packet entrance, the first network packet data exit, and the first node,
passing the first packet having the first information attached thereto from the first intermediary node on the first network to a second intermediary node on the second network;
passing the first packet having the first information attached thereto from the second intermediary node on the network to the second node, whereby the second node is informed as to the first network packet entrance, the first packet network exit, and the first node;
passing a second packet from the second node to the first node, the second packet having attached thereto the same information as that attached to the first packet passed from the first intermediary node to the second intermediary node, plus information indicative of the packet exit of the second network and the packet entry of the second network, wherein passing the second packet from the second node to the first node comprises passing the second packet by way of the second network packet data exit and the first network packet entrance in accordance with the information attached to the second packet, and
subsequently passing packets between the first and second nodes by way of the first network packet data entry and packet exit and the second network packet data entry exit in accordance with the information indicative of the first network packet data entry and packet exit and the second network packet data entry and packet exit exchanged between the first and second nodes by way of the information attached to the first and second packets.

2. The method according to claim 1, further comprising making the first intermediary node on the first network aware of the presence of the first node on the first network.

3. The method according to claim 4, wherein the first node indicates its presence on the first network by sending a multicast message over the first network.

4. The method according to claim 5, wherein the first network comprises a plurality of said first nodes, wherein sending a multicast message over the first network comprises a predetermined first node on the first network sending a multicast message to at least some of the other first nodes on the first network.

5. The method according to claim 1, wherein the second intermediary node passes the first packet having the first information attached thereto to the second node by way of a multicast message.

6. The method according to claim 7, wherein the second network comprises a plurality of second nodes, wherein passing the first packet having the first information attached thereto comprises the second intermediary node sending a multicast message to at least some of the other second nodes on the second network.

7. The method according to claim 1, wherein the first intermediary node is an agent running on a server located on the first network.

8. The method according to claim 1, wherein the second intermediary node is an agent running on a server located on the second network.

9. The method according to claim 13, wherein the second intermediary node is an agent running on a server located on the second network.

10. The method according to any one of claims 13 to 15, in which the agent is capable of both multicast and unicast packet communication.

11. The method according to claim 1, wherein the first and second nodes on the first and second networks are network servers and the first and second intermediary nodes are agents running on respective servers on the first and second networks, respectively.

12. A method of defining communication paths between a first network and a second network, the first and second networks each including a packet entry and a packet exit, respectively, comprising:
conveying a first network packet data entry definition and a first network packet data exit definition from a first agent operating on the first network to a second agent operating on the second network;
conveying the first network packet data entry and exit definitions from the second agent to a server on the second network, thereby informing the server on the second network as to the first network packet data entry and exit definitions;
conveying the first network packet data entry and exit definitions and definitions of a second network packet data entry and exit from the server on the second network to a server on the first network via the second network packet data exit and the first network packet data entry, thereby informing the server on the first network as to the second network packet data entry and exit definitions;
subsequently conveying at least one of:
packets from the server on the first network to the server on the second network via first network packet data exit and the second network packet data entry; and
packets from the server on the second network to the server on the first network via the second network packet data exit and the first network packet data entry.

13. The method according to claim 19, wherein conveying a first network packet data entry definition and a first network packet data exit definition from a first agent operating on the first network to a second agent operating on the second network comprises conveying a host and port corresponding to the server on the first network from the server on the first network to the first agent.

14. The method according to claim 19, wherein the first network packet data entry and exit definitions and the second network packet data entry and exit definitions are host and port pairs corresponding to the first and second networks, respectively.

15. The method according to claim 19, wherein conveying the first network packet data entry and exit definitions and definitions of a second network packet data entry and exit from the server on the second network to a server on the first network via the second network packet data exit and the first network packet data entry, further includes conveying a host and port corresponding to the server on the first network.

16. The method according to claim 20, wherein conveying a host and port corresponding to the server on the first network from the server on the first network to the first agent comprises sending a multicast message from the server on the first network to the first agent.

17. The method according to claim 19, wherein conveying the first network packet data entry and exit definitions from the second agent to a server on the second network comprises sending a multicast message from the second agent to the server on the second network.
